(19) United States
(12) Patent Application Publication
(10) Pub. No.: US 2015/0028038 A1
(43) Pub. Date: Jan. 29, 2015

(54) Tubular Body and Oil Pan Comprising Such a Tubular Body

(71) Applicant: Ralf Franz, Bad Urach (DE)

(72) Inventor: Ralf Franz, Bad Urach (DE)

(73) Assignee: ElringKlinger AG, Dettingen (DE)

(21) Appl. No.: 14/454,445

(22) Filed: Aug. 7, 2014

Related U.S. Application Data
(63) Continuation of application No. PCT/EP2013/052216, filed on Feb. 5, 2013.

(30) Foreign Application Priority Data
Feb. 7, 2012 (DE) 102012100988.0

(51) Int. Cl. F16N 31/00

(52) U.S. Cl. CPC F16N 31/004
USPC 220/573

(57) ABSTRACT

In order to enable a tubular body and an oil pan to be manufactured as cost-effectively as possible, it is proposed that the tubular body comprise a partial tubular body extending over a first partial circumference of a tubular section, and a partial tubular body complementary to the former and extending over the partial circumference that is still free, said partial tubular bodies having connection surfaces in contact with each other along a separating surface following a course of the tubular body and being connected together along said connection surfaces by use of joining techniques.

### CROSS-REFERENCE TO RELATED PATENT APPLICATIONS

This application is a continuation of international application No. PCT/EP2013/052216 filed on Feb. 5, 2013.

This patent application claims the benefit of international application No. PCT/EP2013/052216 of Feb. 5, 2013 and German application number 10 2012 100 988.0 of Feb. 7, 2012, the teachings and disclosure of which are hereby incorporated in their entirety by reference thereto.

### BACKGROUND OF THE INVENTION

The invention relates to a tubular body that can be manufactured by an injection moulding process.

Furthermore, the invention relates to an oil pan comprising a tubular body that can be manufactured by an injection moulding process.

Oil pans with a tubular body are known for example from DE 10 2004 024 517 A1.

With these oil pans and tubular bodies, it is important that the construction be cost-effective to manufacture.

Therefore, the object underlying the invention is to enable a tubular body and an oil pan to be manufactured as cost-effectively as possible.

### SUMMARY OF THE INVENTION

In accordance with the invention, this object is accomplished in a tubular body of the type described at the outset by the tubular body comprising a partial tubular body extending over a first partial circumference of a tubular section, and a partial tubular body complementary to the former and extending over the partial circumference that is still free, said partial tubular bodies having connection surfaces in contact with each other along a separating surface following a course of the tubular body and being connected together along said connection surfaces by use of joining techniques.

The advantage of the solution in accordance with the invention is seen in that it affords the possibility for the respective partial tubular bodies to be made from simple moulds and therefore to be cost-effective to produce.

It is particularly advantageous for the tubular body to comprise more than two interconnected partial tubular bodies as in this case the cost benefits become particularly significant.

In particular, provision is made for partial tubular bodies which succeed each other along a course of the tubular body and which in each case extend only over a partial circumference of the respective tubular section to form a coherent tubular body element.

That is, the tubular body element which comprises only one partial tubular body in each tubular section provides the possibility of providing a stable base structure for the tubular body which is completed in each case by the complementary partial tubular body to form the tubular section.

The tubular body element could also be configured such that it is assembled from a plurality of partial tubular bodies.

However, it is particularly advantageous for the tubular body element to be a part that is manufactured as a single piece forming the successive partial tubular bodies, said part providing the stable base structure for the tubular body, wherein this tubular body element as well is still easy to manufacture because of its construction from partial tubular bodies.

It is even more preferable for the tubular body element to have end elements integrally formed thereon, in particular integrally formed in one piece therewith, so that the end elements can be formed at the same time as the tubular body element.

Such end elements may for example take the form of connecting elements between which the tubular body extends, or one of the end elements may be a functional element, such as a suction element or a discharge element.

No further details have been given so far on the configuration of the partial tubular bodies themselves.

Thus, each partial tubular body, at least each complementary partial tubular body, could be independent of other elements such as housing bodies.

In particular where a tubular body constructed in accordance with the invention is integrated in a housing body, it is advantageous for one of the partial tubular bodies to be integrally formed on the housing body because in this case it is possible for the partial tubular body not only to be assembled together but also to be fixedly connected to the housing body.

In the partial tubular bodies constructed in accordance with the invention, provision is in particular made for the partial tubular bodies to have longitudinal openings facing towards the respective complementary partial tubular bodies, said longitudinal openings being closingly covered by the complementary partial tubular bodies, i.e. each partial tubular body together with the complementary partial tubular body associated therewith forms a tubular section that is closed in the circumferential direction.

In particular in the case of successive partial tubular bodies, provision is made for the successive longitudinal openings to extend in non-contacting or non-penetrating relationship with each other, meaning that each opening has an opening edge that completely surrounds the opening, said opening edge not transitioning into the opening edge of a next opening but instead each of the successive openings having an opening edge of its own.

For example, provision is made for successive longitudinal openings to be arranged relative to one another such that they are angularly offset from one another in a circumferential direction.

In the simplest case, the longitudinal openings are arranged such that they face in opposite directions, i.e. such that they are arranged on opposite sides of for example a tubular body element.

In particular to enable easy manufacturability of a tubular body element having successive partial tubular bodies, it is advantageous for the longitudinal opening associated with one partial tubular body and the longitudinal opening associated with the next partial tubular body, when projected to a longitudinal middle surface, to at least contact each other or overlap each other.

A particularly advantageous embodiment of a tubular body constructed in accordance with the invention has at least one curvature and in this instance it is advantageous for the one partial tubular body to be a partial tubular body positioned on the inside of curvature, while the complementary partial tubular body is a partial tubular body positioned on the outside of curvature.

That is, in this case the partial tubular bodies are configured such that one of them forms the circumferential area on the inside of curvature and the other forms the circumferential area on the outside of curvature of the respective tubular section having the curvature.

In a particularly advantageous embodiment of a tubular body constructed in accordance with the invention, it is provided for said tubular body to comprise a plurality of curvatures and, in said plurality of curvatures, for the respective partial tubular bodies on the inside of curvature to form the coherent tubular body element, i.e. for the respective partial tubular bodies on the inside of curvature to be part of the tubular body element, while the partial tubular bodies on the outside of curvature form the complementary partial tubular bodies.

In this case it is advantageously provided for the coherent tubular body element comprising the at least one partial tubular body on the inside of curvature to have the end elements integrally formed thereon.

In conjunction with the previous description of the individual exemplary embodiments, no details have been provided as to how the connection surfaces are configured.

Thus, it is advantageously provided for the connection surfaces to have connection surface areas that extend transversely relative to each other.

Furthermore, no details have been provided in conjunction with the individual exemplary embodiments as to how the partial tubular bodies are connected.

Thus, one advantageous solution provides for the partial tubular bodies to be connected together by adhesive bonding.

Another advantageous solution provides for the partial tubular bodies to be connected together by welding.

Furthermore, the object indicated at the outset is in accordance with the invention achieved by an oil pan for engines, in particular for combustion engines, wherein a tubular body mounted in the oil pan is configured in accordance with any one of the preceding claims.

In particular, provision is made for the tubular body to be part of an oil suction conduit.

Further features and advantages of the invention are the subject of the following description and drawing of an exemplary embodiment.

### BRIEF DESCRIPTION OF THE DRAWINGS

FIG. 1 is a perspective view showing an exemplary embodiment of an oil pan constructed in accordance with the invention, said oil pan comprising a tubular body, constructed in accordance with the invention, as part of an oil suction conduit;

FIG. 2 is a section along lines 2-2 in FIG. 1;

FIG. 3 is an exploded view of the oil pan and oil suction conduit in accordance with FIG. 1;

FIG. 4 is an exploded view of the parts making up the oil suction conduit;

FIG. 5 is a perspective view of a tubular body element constructed in accordance with the invention, comprising an end element configured in the form of a suction part and an end element configured as a connecting part;

FIG. 6 is a detail in perspective view of a transition area between one longitudinal opening and another longitudinal opening following the former;

FIG. 7 is a rotated perspective view of the transition area in accordance with FIG. 6;

FIG. 8 is a perspective view of the transition area illustrating complementary partial tubular bodies shown as connected to the partial tubular bodies by way of joining techniques;

FIG. 9 is a perspective view of the oil pan in accordance with FIG. 1, illustrating an elastomeric sealing element for an oil level gauge rod channel; and

FIG. 10 is a perspective view of an oil drain opening with an insert provided therefor.

### DETAILED DESCRIPTION OF THE INVENTION

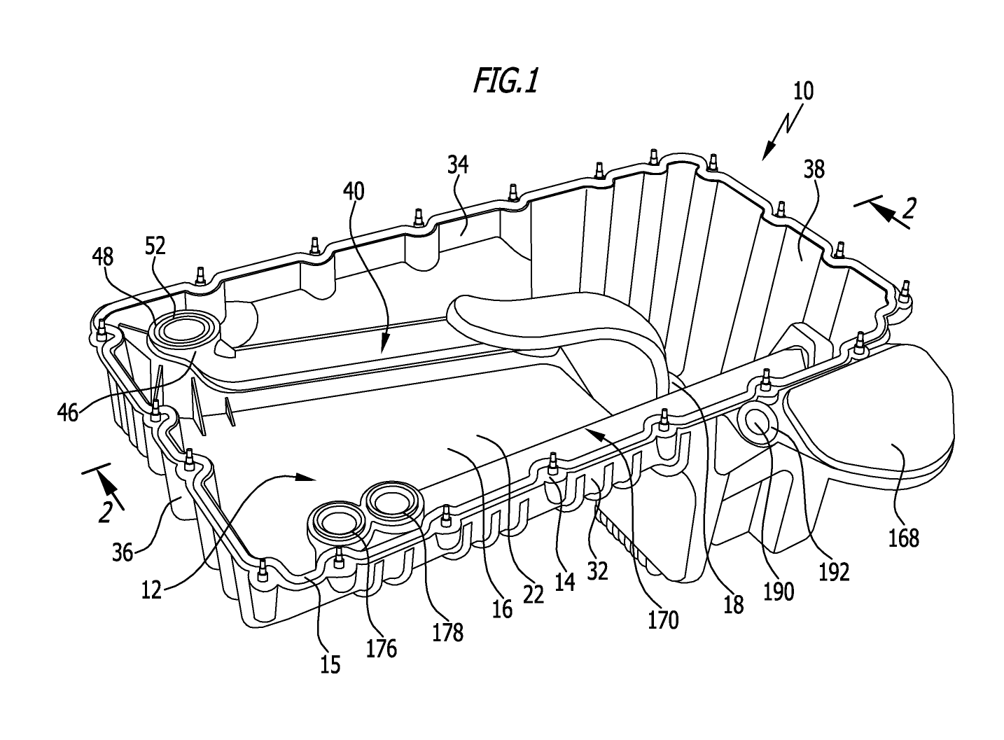

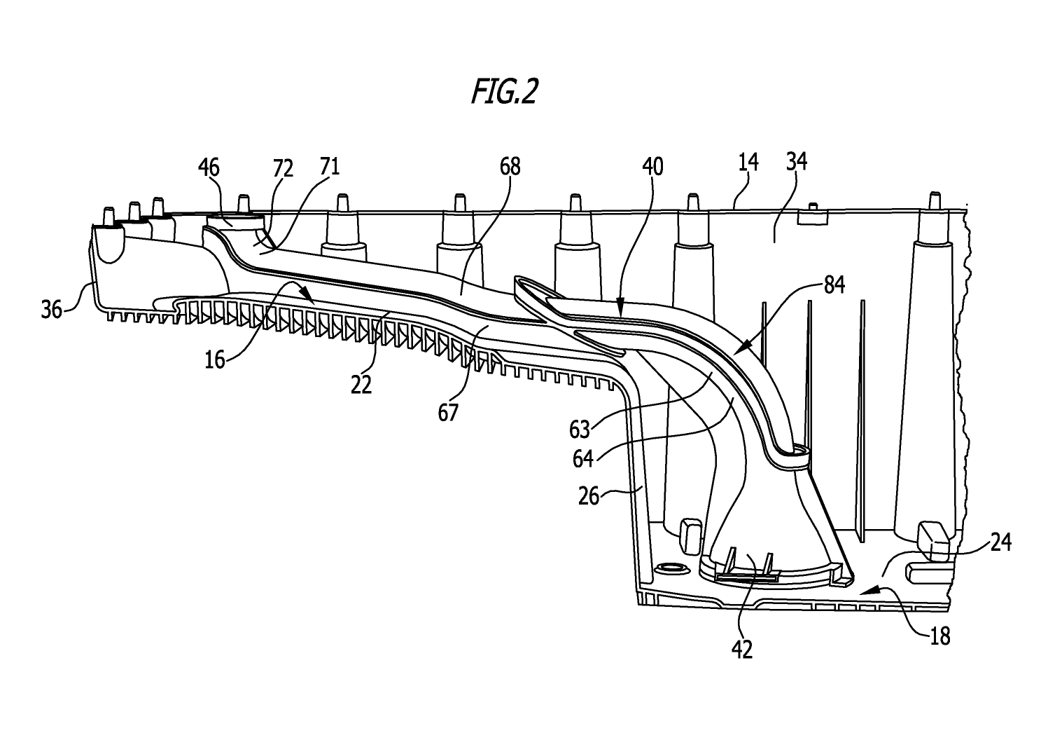

As illustrated in FIG. 1, an exemplary embodiment of a motor oil pan 10 constructed in accordance with the invention, for use in a combustion engine, comprises a pan body generally designated 12 which, in the mounted state, extends downwardly in the direction of gravity from a mounting flange 14 which has a gasket 15 inserted therein and is for fixing the pan body 12 to an engine block of the combustion engine, and comprises a high-lying pan area 16 and a low-lying pan area 18, wherein a floor area 22 of the high-lying pan area 16 is arranged at a distance away from the mounting flange 14 that is less than a distance that a floor area 24 of the low-lying pan area 18 is arranged away from the mounting flange 14 and wherein the floor area 22 of the high-lying pan area 16 transitions into a stepped wall portion 26 that slopes downwards towards the floor area 24.

Extending between the mounting flange 14 and the respective floor areas 22 and 24 are longitudinal side walls 32 and 34 and transverse side walls 36 and 38.

In accordance with the invention, the entire pan body 12, comprising the mounting flange 14 with the longitudinal side walls 32 and 34, the transverse side walls 36 and 38 as well as the floor areas 22 and 24 and the stepped wall portion 26, is configured as a one-piece plastics part which is preferably manufactured by an injection moulding process, wherein the plastics material is a thermoplastic material, such as a polyamide.

The floor area 22 of the high-lying pan area 16 is configured such that all of the oil accumulating therein flows into the low-lying pan area 18 and accumulates above the floor area 24 thereof.

In order to enable oil accumulating in the low-lying pan area 18 to be aspirated, the motor oil pan 10 is provided with an oil suction conduit, generally designed at 40, which is preferably fixedly connected to the pan body 12 and comprises at one end thereof a suction part 42 which flares out into a trumpet-like shape and is for example fixedly connected to a strainer element 44, and comprises at the other end thereof a connecting part 46 arranged at an approximate level of the mounting flange 14, said connecting part 46 being preferably connected to a connecting flange 48 that itself is additionally provided with a sealing element 52 made of elastomer.

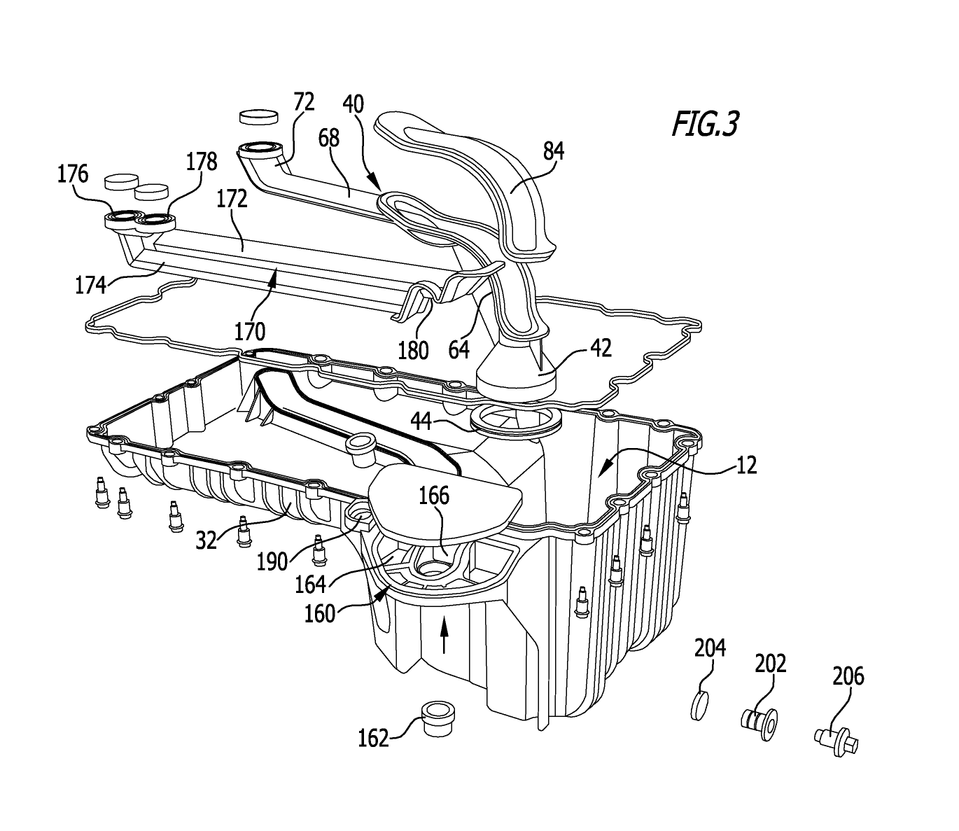

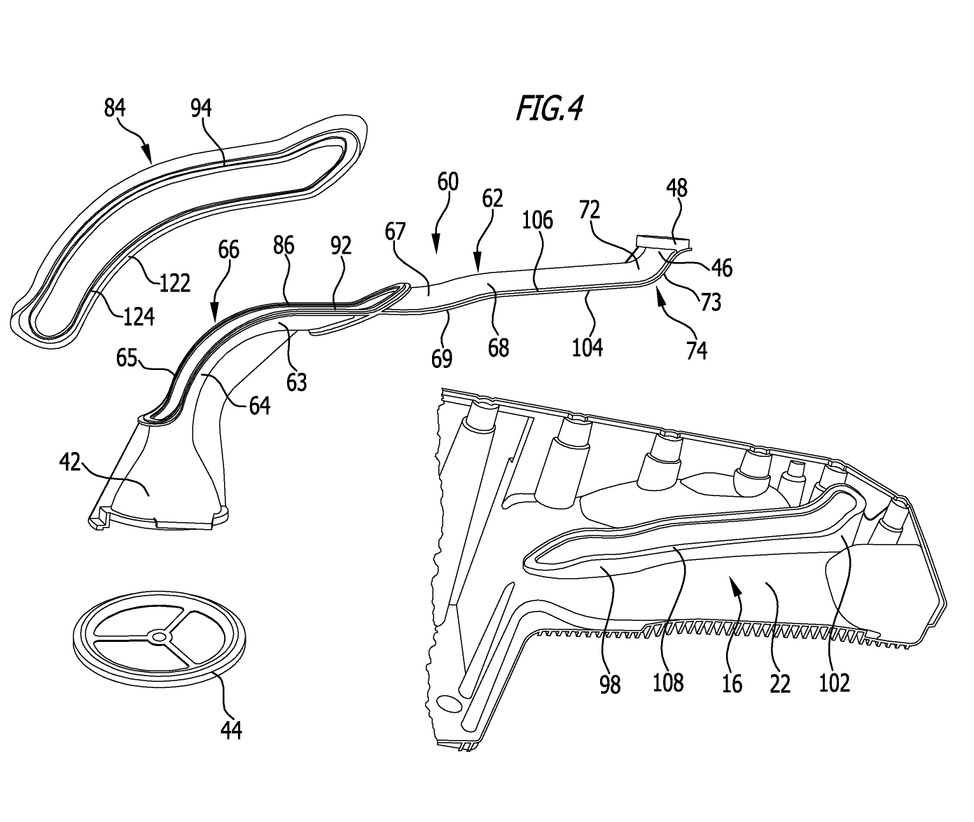

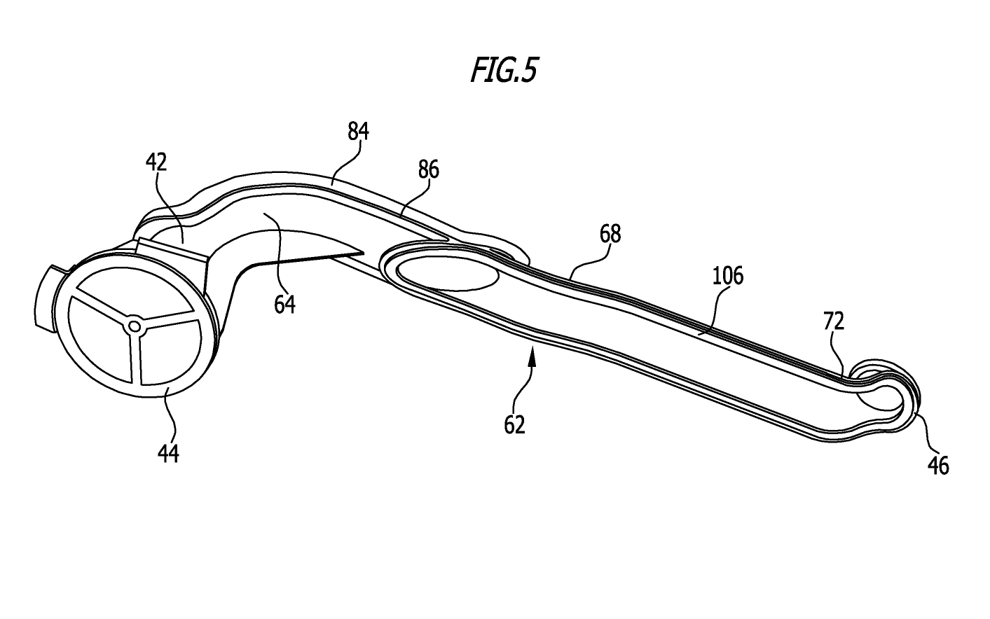

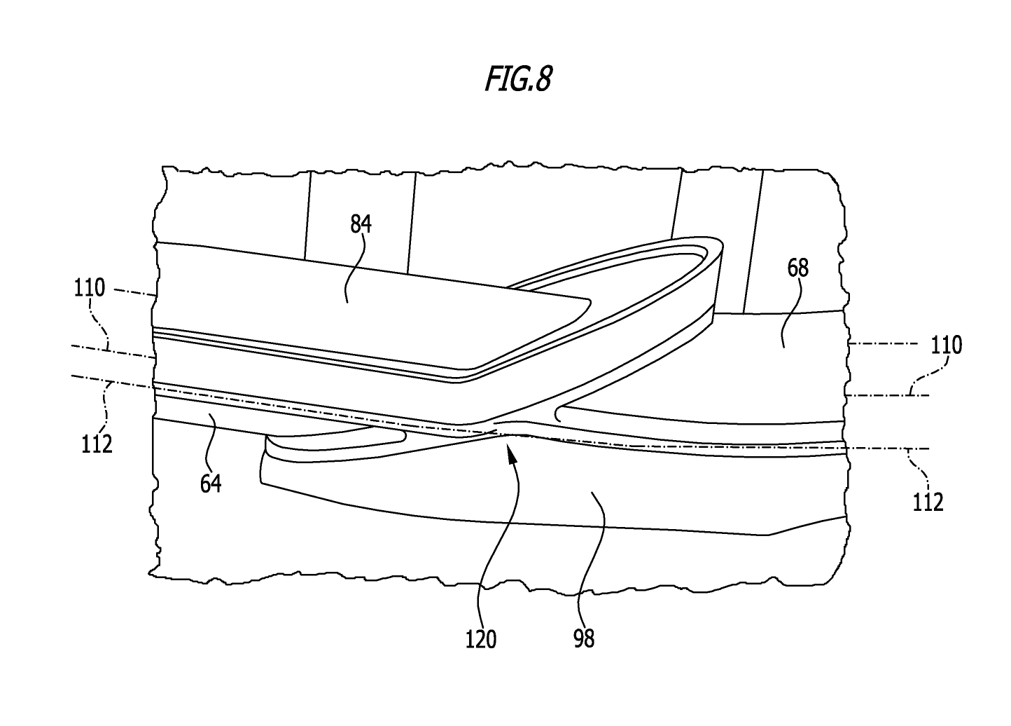

As shown in FIGS. 3 to 8 in particular, the oil suction conduit 40 comprises a tubular body 60 having multiple curvatures and extending between the suction part 42 and the connecting part 46, said tubular body 60 comprising a plurality of partial tubular bodies, all of which being advantageously manufacturable by injection moulding techniques.

Thus, the tubular body 60 comprises a coherent tubular body element 62 having at a first end thereof, integrally formed in one piece therewith, the suction part 42 as an end element and having at a second end thereof, integrally formed thereon, the connecting part 46, including the connecting flange 48, as an end element.

Starting from the suction part 42, the tubular body element 62 comprises a first partial tubular body 64 on the inside of curvature having a longitudinal opening 65 that faces towards an exterior of curvature and being arranged in the area of a first curvature 66 of the tubular body 60 and extending over a partial circumference on the inside of curvature of the tubular body 60 in a tubular section 63 comprising said partial tubular body 64.

Following the first partial tubular body 64 on the inside of curvature is an intermediate partial tubular body 68 having a longitudinal opening 69 which faces in a direction opposite to that of the longitudinal opening 65. Between the first partial tubular body 64 on the inside of curvature and a second partial tubular body 72 on the inside of curvature, the intermediate partial tubular body 68 likewise extends over a partial circumference of the tubular body 60 in a tubular section 67 that comprises said partial tubular body 68.

The second partial tubular body 72 on the inside of curvature is arranged in the area of a second curvature 74, between the intermediate partial tubular body 68 and the connecting part 46 with the connecting flange 48, said second partial tubular body 72 having a longitudinal opening 73 that faces towards an exterior of curvature and into which the longitudinal opening 69 transitions.

The second partial tubular body 72 on the inside of curvature extends over a partial circumference on the inside of curvature of the tubular body 60 in a tubular section 71 comprising said partial tubular body 72.

Preferably, the first partial tubular body 64 on the inside of curvature, the intermediate partial tubular body 68 and the second partial tubular body 72 on the inside of curvature are each configured as a tubular half-body.

To complete the tubular body 60 to form the circumferentially closed tubular sections 63, 67 and 71, the invention provides that in the area of the first partial tubular body 64 on the inside of curvature said first partial tubular body 64 on the inside of curvature has mounted thereon a first partial tubular body 84 which is on the outside of curvature and therefore complementary to the former, wherein the two partial tubular bodies 64 and 84 are, by way of connection surfaces 92 and 94 adjacent to a separating surface 86 and extending in the separating surface 86, connected together by joining methods, such as adhesive bonding or welding, so that the partial tubular body 64 on the inside of curvature and the first partial tubular body 84 on the outside of curvature complete one another to form the tubular section 63 of the tubular body 60.

Furthermore, it is also possible for the intermediate partial tubular body 68 and the second partial tubular body 72 on the inside of curvature to be completed by a complementary intermediate partial tubular body 98 and a second complementary partial tubular body 102 that is positioned on the outside of curvature and integrally formed on the intermediate partial tubular body 98, to form the tubular sections 67 and 71 of the tubular body 60, both of which likewise having connection surfaces 106 and 108 adjacent to a continuous separating surface 104.

Overall, the tubular body 60 is thus formed by the first partial tubular body 64 on the inside of curvature and the first complementary partial tubular body 84 on the outside of curvature, the intermediate partial tubular body 68 and the complementary intermediate partial tubular body 98, and the second partial tubular body 72 on the inside of curvature and the second complementary partial tubular body 102 on the outside of curvature, all of which are connected with each other by the joining together thereof.

In the illustrated exemplary embodiment, the complementary intermediate partial tubular body 98 and the second complementary partial tubular body 102 on the outside of curvature are integrally formed in one piece with the floor area 22 of the high-lying pan area 16 of the oil pan 10; in this way, the tubular body 60 itself is already fixedly connected to the pan body 12.

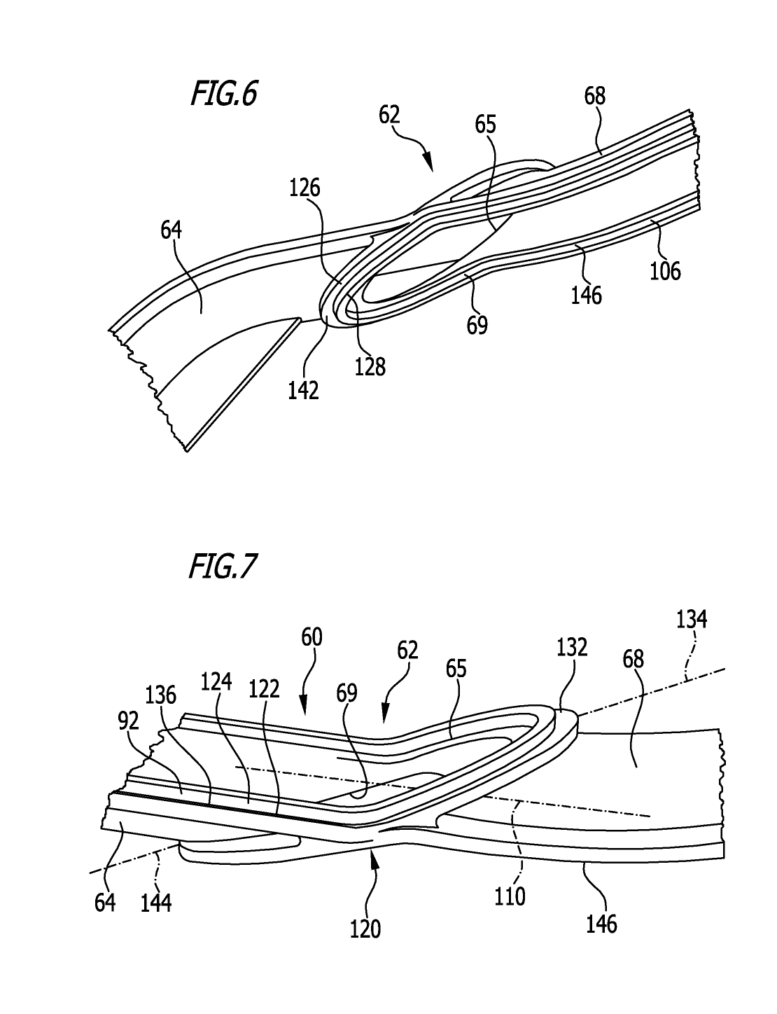

Due to the fact that in the tubular body element 62 constructed in accordance with the invention the first partial tubular body 64 on the inside of curvature and the intermediate partial tubular body 68 are arranged on opposite sides relative to a geometric central axis 110 of the tubular body 60, the tubular body element 62 presents a transition area 120 which is configured such that while the longitudinal opening 65 and the longitudinal opening 69 are arranged in non-contacting and non-penetrating relationship with each other, projections of the two on a geometric longitudinal middle surface 112 that extends through the geometric central axis 110 do overlap with each other, as is illustrated in FIGS. 6 and 7, so that the tubular body element 62 can be manufactured using an injection mould that is of simple construction and can have cores engaging in the tubular sections 63 and 67 through the longitudinal openings 65 and 69.

It is thus possible for the tubular body element 62 to be manufactured using injection moulds that are of simple construction and easy to use.

For securely forming a joint connection between the first partial tubular body 64 on the inside of curvature and the first partial tubular body 84 on the outside of curvature, the connection surfaces 92 and 94 are preferably configured such that they have connection surface areas 122 and 124 which extend transversely relative to each other and interengage in form-locking connection, thus providing for a stable joint connection between the first partial tubular body 64 on the inside of curvature and the first partial tubular body 84 on the outside of curvature, wherein the joint connection is produced by welding or adhesive bonding in particular.

In like manner, the intermediate partial tubular body 68 and the complementary intermediate partial tubular body 98 as well as the second partial tubular body 72 on the inside of curvature and the second complementary partial tubular body 102 on the outside of curvature are, in the area of the connection surfaces 106 and 108 thereof, also provided with connection surface areas 126 and 128 that likewise run transversely relative to each other in order to enable form-locking engagement therebetween.

The connection of the intermediate partial tubular body 68 with the intermediate partial tubular body 98 and of the second partial tubular body 72 on the inside of curvature with the second partial tubular body 102 on the outside of curvature is also made in the form of a joint connection, preferably likewise by welding or adhesive bonding.

Preferably, as shown in FIG. 7, provision is made in the transition area 120 for the connection surface 92, which initially extends approximately parallel to the geometric longitudinal middle surface 112 of the tubular body 60, to transition from a middle area 136 extending approximately parallel to the longitudinal middle surface 112 into an end area 132 which is oriented approximately parallel to a geometric surface 134 extending transversely to the central axis 110 and also extending transversely, in particular at an angle, to the longitudinal middle surface 112, wherein the end area 132 includes an angle of less than 90°, preferably less than 60°, with the geometric central axis 110 and includes an angle of greater than 90°, preferably greater than 120°, with the middle area 136 of the connection surface 92, which extends approximately parallel to the longitudinal middle surface 112.

Furthermore, the course of the connection surface 94, which is complementary to the connection surface 92, conforms to the course of the connection surface 92.

In like manner, as is illustrated in FIG. 6, an end area 142 of the connection surface 106 also extends in a surface 144 parallel to, preferably coincident with, the geometric surface 134, said surface 144 also including an angle of less than 90° with the central axis 110 of the tubular body 60, and further extends such that the end area 142 also includes an angle of greater than 90°, preferably greater than 120°, with a middle area 146 of the connection surface 106 that extends approximately parallel to the longitudinal middle surface 112.

Furthermore, the course of the connection surface 108, which is complementary to the connection surface 106, conforms to the course of the connection surface 106.

Moreover, in the area of the longitudinal side wall 32, the pan body 12 is provided with a mounting formation 160 integrally moulded in one piece therewith that is for mounting an oil filter and capable of having inserted therein a threaded insert 162 which serves for screwing the oil filter thereto.

Furthermore, although not seen in detail, the integrally moulded mounting formation 160 is provided with flow channels 164 and 166 integrally formed thereinto, said flow channels 164 and 166 being closed by a cover 168 and capable of communication with a set of oil conduits 170, said set of oil conduits 170 comprising a dirty oil conduit 172 and a clean oil conduit 174 for conducting filtered oil.

The set of oil conduits 170 in turn is provided with connecting flanges 176 and 178 via which dirty oil can be supplied and clean oil removed, respectively, and a joint connection area 180 via which communication with the flow channels 164 and 166 of the integrally moulded mounting formation 160 can be established by joining techniques.

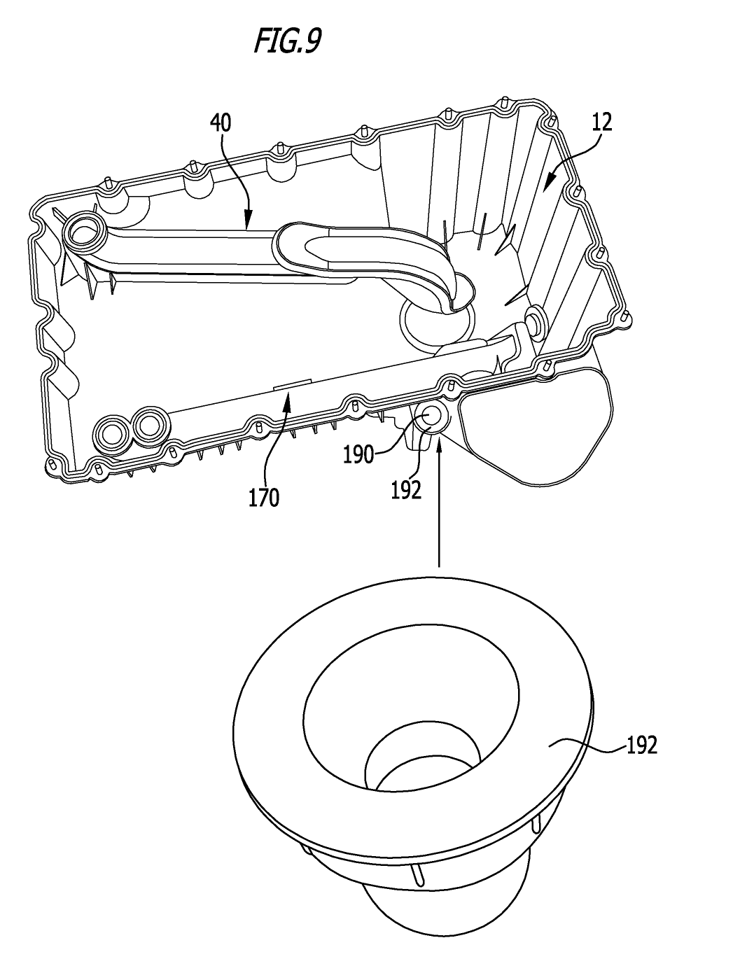

Furthermore, the integrally moulded mounting formation 160 is provided with an oil level gauge rod channel 190 integrally formed therein and via which an oil level gauge rod is insertable, wherein the oil level gauge rod channel 190 is capable of having an elastomeric sealing element 192 inserted therein for closing off said oil level gauge rod channel 190, as illustrated in FIG. 9.

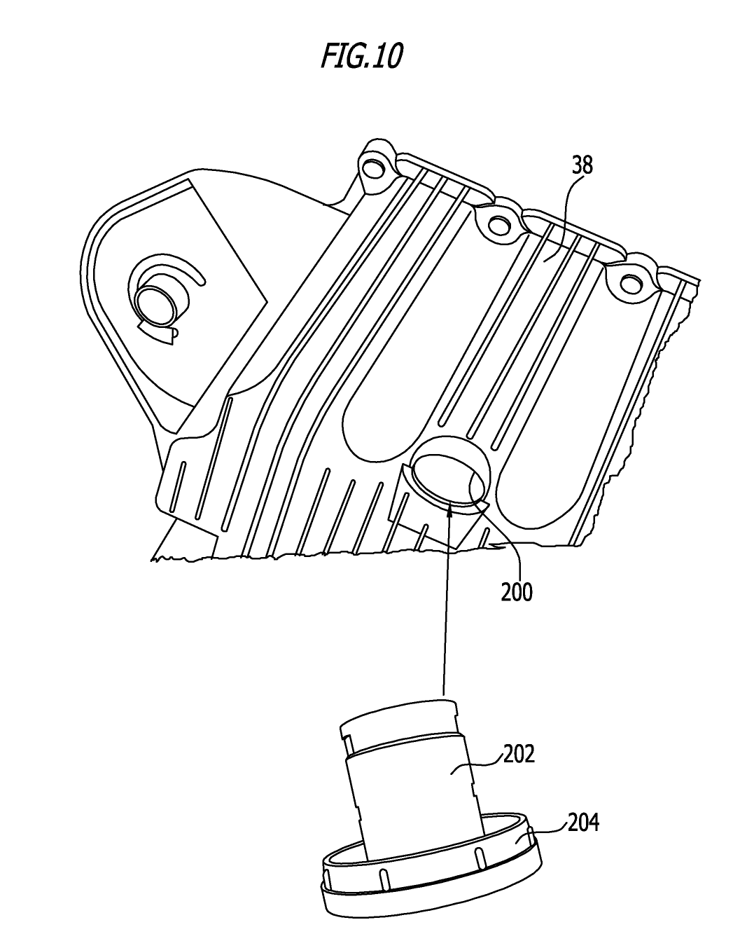

Finally, as shown in FIG. 10, the transverse side wall 38 is, in the vicinity of the low-lying bottom area 24, provided with an oil drain opening 200 integrally formed in the pan body 12, said oil drain opening 200 being capable of having a threaded insert 202 with an axial gasket 204 inserted therein and fixed thereto by way of a joint connection, wherein the threaded insert 202 is capable of being closed off by way of an oil drain plug 206.

1. Tubular body that is manufacturable by injection moulding, wherein the tubular body comprises a partial tubular body extending over a first partial circumference of a tubular section, and a partial tubular body complementary to the former and extending over the partial circumference that is still free, said partial tubular bodies having connection surfaces in contact with each other along a separating surface following a course of the tubular body and being connected together along said connection surfaces by use of joining techniques.

2. Tubular body as defined in claim 1, wherein the tubular body comprises more than two interconnected partial tubular bodies.

3. Tubular body as defined in claim 1, wherein partial tubular bodies which succeed each other along a course of the tubular body and which in each case extend over a partial circumference of the respective tubular section form a coherent tubular body element.

4. Tubular body as defined in claim 3, wherein the tubular body element is a part that is manufactured as a single piece forming the successive partial tubular bodies.

5. Tubular body as defined in claim 3, wherein the tubular body element has end elements integrally formed thereon.

6. Tubular body as defined in claim 1, wherein one of the partial tubular bodies is integrally formed on a housing body.

7. Tubular body as defined in claim 1, wherein the partial tubular bodies have longitudinal openings facing towards the respective complementary partial tubular bodies, said longitudinal openings being closingly covered by the complementary partial tubular bodies.

8. Tubular body as defined in claim 7, wherein successive longitudinal openings extend in non-contacting or non-penetrating relationship with each other.

9. Tubular body as defined in claim 7, wherein in a transition area, the longitudinal opening associated with one partial tubular body and the longitudinal opening associated with the next partial tubular body, when projected to the longitudinal middle surface, at least contact each other or overlap each other.

10. Tubular body as defined in claim 1, wherein the one partial tubular body is a partial tubular body positioned on the inside of curvature, while the complementary partial tubular body is a partial tubular body positioned on the outside of curvature.

11. Tubular body as defined in claim 10, wherein the tubular body comprises a plurality of curvatures and wherein in said plurality of curvatures the respective partial tubular bodies on the inside of curvature form the coherent tubular body element.

12. Tubular body as defined in claim 11, wherein the coherent tubular body element comprising the at least one partial tubular body on the inside of curvature has the end elements integrally formed thereon.

13. Tubular body as defined in claim 1, wherein the connection surfaces have connection surface areas that extend transversely relative to each other.

14. Tubular body as defined in claim 1, wherein the partial tubular bodies are connected together by adhesive bonding.

15. Tubular body as defined in claim 1, wherein the partial tubular bodies are connected together by welding.

16. Oil pan for engines, in particular for combustion engines, wherein a tubular body mounted in the oil pan is configured as defined in claim 1.

17. Oil pan as defined in claim 16, wherein the tubular body is part of an oil suction conduit.
